(19) United States
(12) Patent Application Publication
(10) Pub. No.: US 2007/0234052 A1
(43) Pub. Date: Oct. 4, 2007

(54) Electromechanical lock system

(76) Inventor: Steven E. Campisi, Elkhorn, NE (US)

Correspondence Address: SUITER WEST SWANTZ PC LLO, 14301 FNB PARKWAY, SUITE 220, OMAHA, NE, 68154, US

(21) Appl. No.: 11/400,011

(22) Filed: Apr. 6, 2006

Related U.S. Application Data
(63) Continuation-in-part of application No. 10/844,262, filed on May 12, 2004.
Application No. 10/844,262 is a continuation-in-part of application No. 10/603,887, filed on Jun. 25, 2003.
(60) Provisional application No. 60/463,297, filed on Apr. 16, 2003.
(60) Provisional application No. 60/417,607, filed on Oct. 10, 2002.
(60) Provisional application No. 60/391,532, filed on Jun. 25, 2002.
(60) Provisional application No. 60/668,722, filed on Apr. 6, 2005.

(51) Int. Cl. H04L 9/00

(52) U.S. Cl. 713/169

(57) ABSTRACT

The present invention is an electromechanical lock system which includes an electromechanical lock and a release device for releasing the electromechanical lock. In one embodiment of the invention, the electromechanical lock may be released when a release device is placed on, within or in proximity to an electromechanical lock. The electromechanical lock may operate on power derived from an external power source, and may receive power from a release device. A release device in accordance with the present invention may also include a biometric sensor for sensing a biometric feature of a user. A release device may be activated by receipt of an authenticated biometric feature. When the biometric feature has been authenticated, the release device may be activated and may supply power to the electromechanical lock of the present invention. Upon successful verification of key information, or code of the release device, the electromechanical lock of the present invention may release the lock mechanism and may allow access to the protected area.

### CROSS REFERENCE TO RELATED APPLICATIONS

The present application is a continuation-in-part application claiming priority under 35 U.S.C. §120 to the United States Non-Provisional patent application Ser. No. 10/844,262 filed on May 12, 2004 which is a continuation-in-part application claiming priority under 35 U.S.C. §120 to the United States Non-Provisional patent application Ser. No. 10/603,887, filed on Jun. 25, 2003, which claimed priority under 35 U.S.C. 119(e) to United States Provisional Patent Application Ser. Nos. 60/463,297, filed Apr. 16, 2003, 60/417,607, filed Oct. 10, 2002, and 60/391,532, filed Jun. 25, 2002.

The present application also claims the benefit under 35 U.S.C. 119(e) to United States Provisional Application Ser. No. 60/668,722 filed Apr. 6, 2005.

The United States Non-Provisional patent application Ser. No. 10/844,262 filed May 12, 2004, United States Non-Provisional patent application Ser. No. 10/603,887 filed Jun. 25, 2003 and the U.S. Provisional Patent Application Ser. Nos. 60/463,297, 60/417,607, 60/391,532 and 60/668,722 are herein rated by reference in their entireties.

### FIELD OF THE INVENTION

The present invention generally relates to locks, and particularly to an mechanical lock system and method for releasing an electromechanical lock.

### BACKGROUND OF THE INVENTION

Security is of concern to businesses and individuals for a plethora of reasons, including the prevention of identity theft, property theft, industrial espionage, invasion of privacy, and terrorism. In order to protect the content of a protected area, such as a building, room, lock box, file cabinet, locker and the like, locks such as pad locks may be employed to secure the content within the protected area. Often, it may be desirable to grant access to the protected area to a group of individuals while preventing access to a second group of individuals.

However, it is difficult to grant access to particular personnel with conventional lock systems. Conventional pad locks may be released by a particular key, such as a metal instrument, or alternatively via entry of a particular combination of characters, numbers, rotations and the like. Another type of conventional lock system may include a radio frequency (RF) reader which may detect the presence of an access device, such as a key card, within the proximity of the RF reader. A problem with conventional lock systems is the ability to pass the key, combination or access card to people who should not have access to property or area which is secured by the locking system. Another problem associated with lock systems employing a RF reader is the requirement for supplying electrical power to control access. In many typical applications, the areas which are protected by lock systems may be in remote locations where a source of electrical power may not be available.

Therefore, it would be desirable to provide an electromechanical lock system operable in remote locations which securely restricts access to authorized personnel.

### SUMMARY OF THE INVENTION

Accordingly, the present invention is directed to an electromechanical lock system which includes an electromechanical lock and a release device for releasing the electromechanical lock in accordance with an embodiment of the present invention. In one embodiment of the invention, the electromechanical lock may be released when a release device is placed on, within or in proximity to an electromechanical lock. Advantageously, the electromechanical lock may operate on power derived from an external power source and thus may not require an internal power source. According to one embodiment of the invention, the electromechanical lock may operate with power supplied from a release device of the present invention whereby the electromechanical lock may be placed in areas unencumbered by the requirement of a power source.

In a second aspect of the present invention, a release device in accordance with the present invention may include a biometric sensor for sensing a biometric feature of a user. A release device may be activated by receipt of an authenticated biometric feature. When the biometric feature has been authenticated, the release device may be activated and may supply power to the electromechanical lock of the present invention. Upon successful verification of key information, or code from the release device, the electromechanical lock of the present invention may release the lock mechanism and may allow access to the protected area.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 depicts an electromechanical lock system in accordance with an embodiment of the present invention;

FIG. 2 depicts a process of releasing an electromechanical lock in accordance with an embodiment of the present invention;

FIG. 3 depicts a process of releasing an electromechanical lock in accordance with an alternative embodiment of the present invention;

FIG. 4 depicts multiple views of a release device in accordance with an embodiment of the present invention;

FIG. 5 depicts multiple views of a release device in accordance with an alternative embodiment of the present invention; and

FIGS. 6A and 6B depict block diagrams of a release device in accordance with an embodiment of the present invention.

### DETAILED DESCRIPTION OF THE INVENTION

Reference will now be made in detail to the presently preferred embodiments of the invention, examples of which are illustrated in the accompanying drawings.

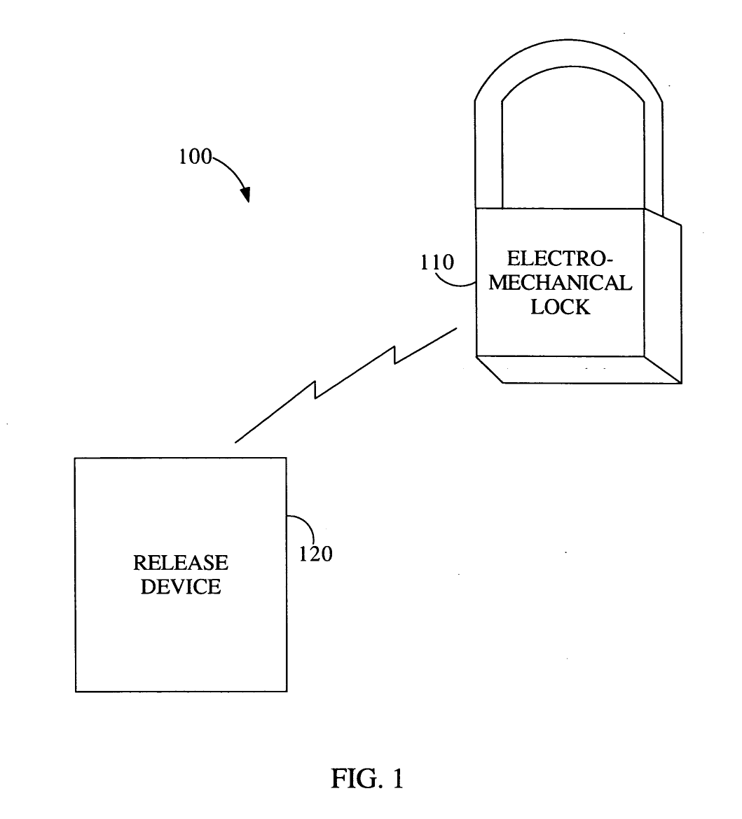

Referring to FIG. 1, an electromechanical lock system 100 in accordance with an embodiment of the present invention is shown. In one embodiment of the invention, electromechanical lock system 100 may include an electromechanical lock 110 and a release device 120. An electromechanical lock 110 may include any lock, including a door lock, pad lock and the like with a releasable latch and an actuator which may release and secure the latch in a desired position. Electromechanical lock 110 may include a RF reader which may be implemented with a transceiver, processor and memory. In an embodiment of the invention, electromechanical lock 110 may be suitable for receiving and processing wireless signals, such as radio frequency (RF) signals, sound waves, infrared and the like. The actuator of the lock may operate upon receipt of code which may be supplied from the release device 120 via a contact or contact-less interface, such as an over-the-air interface.

Release device 120 may be utilized to release a lock mechanism of electromechanical lock 110. Release device 120 may be suitable for receiving and transmitting wireless signals, such as radio frequency (RF) signals, sound waves, infrared and the like. It is contemplated that release device 120 may be a passive RF device or an active RF device. Release device 120 may transmit code, or key information, which operates in conjunction with the electromechanical lock 110 to allow access to a protected area.

It is contemplated that the electromechanical lock 110 may not require an internal or integrated power source. Power may be supplied from a source external to the electromechanical lock during an authentication process. For example, electromechanical lock may not be coupled to an alternating current (AC) source or include an integrated direct current (DC) source such as a battery. In one embodiment of the invention, an external power source, such as a battery or rechargeable battery, may be supplied by a user in conjunction with release device 120 during the authentication process to supply power to the electromechanical lock 110. In an alternative embodiment of the invention, release device 120 may include an integrated power source, such as a battery or rechargeable battery, which may support the operation of the release device and may support the operation of the electromechanical lock 110. Advantageously, in applications where several electromechanical locks may be employed, the operability of electromechanical lock system may be maintained by ensuring the operation of the release device 120 rather than providing an integrated power source for each electromechanical lock 110.

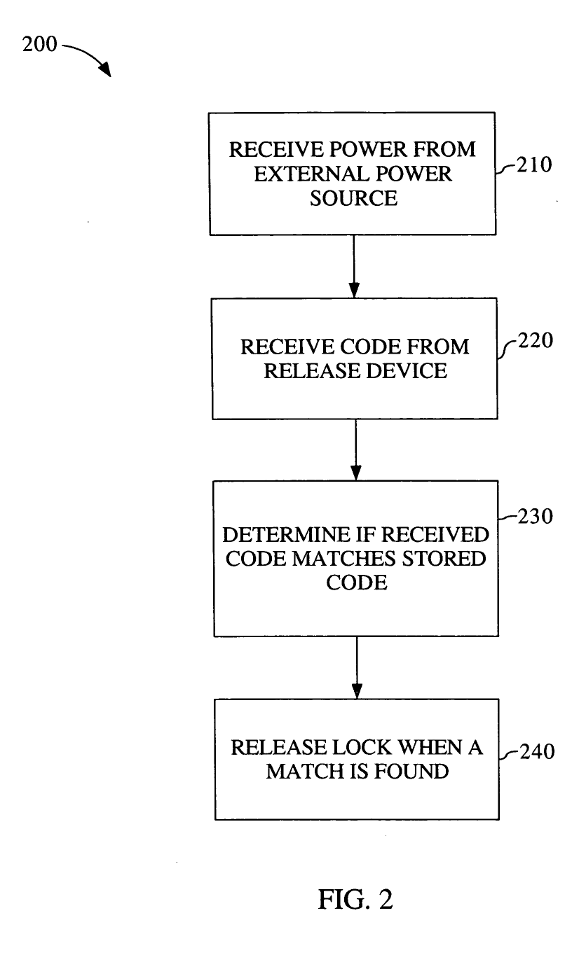

Referring now to FIG. 2, a process of releasing an electromechanical lock in accordance with an embodiment of the present invention is shown. Process 200 may begin by receiving power from an external power source 210. It is contemplated that an external power source, such as a battery, or the power source of the release device may be placed in proximity of an electromagnetic lock to allow power transfer to the electromagnetic lock. It is contemplated that the electromechanical lock may receive power through a contact interface or wirelessly through an inductive transfer of power in accordance with embodiments of the present invention.

A contact interface may refer to a receptacle suitable for securing contacts of a battery to temporarily provide power during the process of releasing the lock. Additionally, release device may include contacts on an external side of its housing to allow coupling to an internal power source, such as a battery. A contact-less interface may refer to wireless energy transfer which may refer to the transfer of electromagnetic energy for power via conduction or induction without a physical connection. In one embodiment of the present invention, the release device may include a ferrite coil which operates with a corresponding ferrite coil within the electromechanical lock to allow a transfer of electrical energy. Through generation of a magnetic flux, a current may be induced in an internal coil of the electromechanical lock in accordance with the present invention. Other forms of wireless energy transfer may be employed such as microwave energy transfer. For example, Fiber lasers may also be employed to provide microwave power transmission.

When power is received, the electromechanical lock may be suitable for receiving code, otherwise known as a key or key data, from the release device 220. After determining the received code matches stored code within the electromechanical lock 230, the lock may be released 240. If the received code does not match the stored code, access may not be granted and the lock may not be released.

In an embodiment of the invention, the release device 120 of FIG. 1 may include a biometric sensor whereby the release device may only be operable upon verification of authenticated biometric feature. Verification of an authenticated biometric feature may include comparing a measured biometric feature with a stored biometric feature to determine if the measured biometric feature matches the stored biometric feature. It is contemplated that an electromagnetic lock may not receive power from a release device until an authenticated biometric feature has been verified. It is further contemplated that biometric sensor may be any type of sensor for measuring a biometric feature. In one embodiment of the invention, the biometric sensor maybe a fingerprint reader and may authenticate a fingerprint of a user via a set of minutia points. However, the biometric input need not be limited to fingerprint matching, but may include other forms of biometric identification including retinal detection, iris detection, DNA matching, blood flow patterns, skin pigment and the like. Additionally, release device 120 may allow multiple biometric feature identification. A biometric feature associated with a plurality of people may be stored within memory of a release device 120. This may be advantageous as multiple codes, or keys, may be stored and may be required to grant access to a protected area. It is contemplated that the codes may be required in a sequential or non-sequential order according to embodiments of the present invention. For example, a first biometric feature may be verified followed by verification of a second and third biometric feature in a prescribed order to gain access. Advantageously, access may only be granted when multiple parties are simultaneously present.

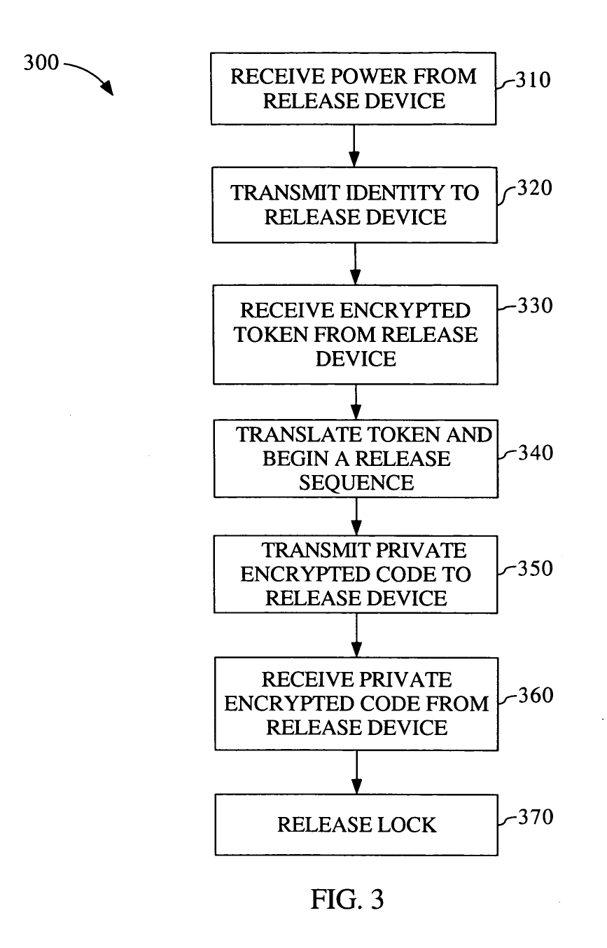

Referring to FIG. 3, a process 300 of releasing an electromechanical lock in accordance with an alternative embodiment of the present invention is shown. Process 300 may begin upon receiving power by the electromechanical lock 310. It is contemplated that power may be received from a release card in accordance with the present invention only when the release card is activated by verification of an authenticated biometric feature. The electromechanical lock may transmit its identity to the release device 320. The release device may confirm a sequence or non-sequence identity of the electromechanical lock. The electromechanical lock may receive an encrypted token from the release device 330. It is contemplated that the token may identify the identity of the release device. The electromechanical lock may translate the token and may begin the unlock sequence 340. The electromechanical lock may further transmit a private encrypted code (PEC) to the release device 350. The release device may receive the PEC and may transmit the PEC of the release device. When the electromechanical lock receives a corresponding PEC of the release device 360, access may be granted and the lock may be released 370. Advantageously, process 300 may be performed in a sub-second time frame.

It is contemplated that the transfer of power from the release device to the electromechanical lock may be effectuated in a variety of ways. The transfer of power may be through a contact interface and a contact-less interface, such as a wireless interface. In an embodiment of the invention, the release device may be inserted into an electromechanical lock via a male to female interface.

In an embodiment of the invention, the electromechanical lock may include a capacitive power source that may provide power to the electromechanical lock for several seconds after being powered by a release device. This may provide an amount of stored energy which may be utilized during a verification process to determine if the electromechanical lock may grant access to a release device. Additionally, this may allow multiple persons to authenticate biometric features to open the lock with one or more release devices. It is contemplated that a release device may also store multiple biometric features of multiple people. This may allow release of a lock via a single release device to multiple persons, all of which must submit their biometric feature in a sequential or non-sequential matter to gain access to a protected area according to various embodiments of the present invention.

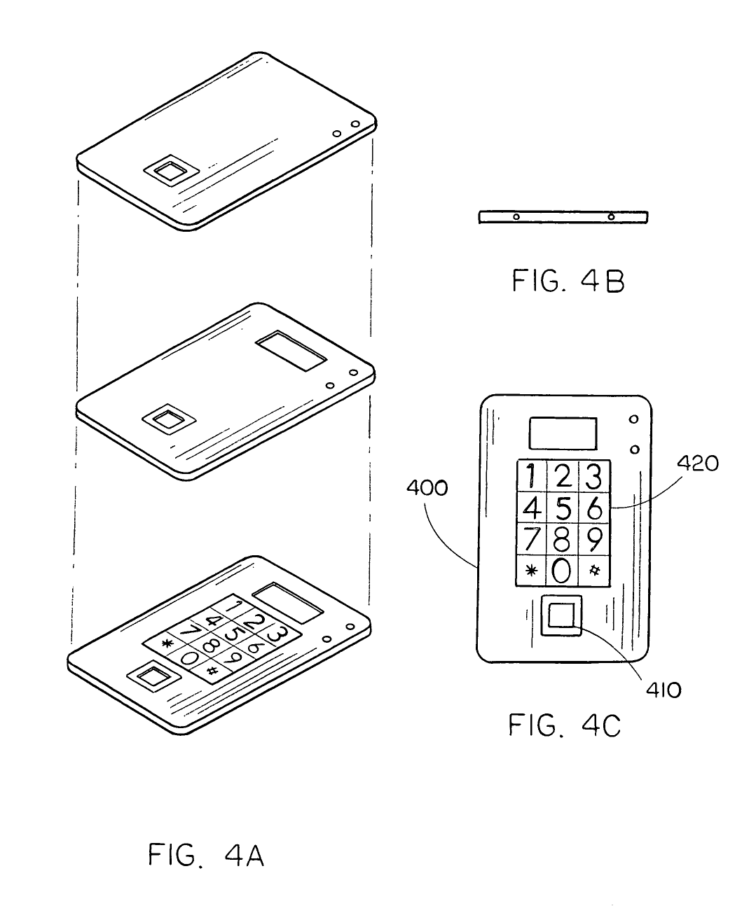

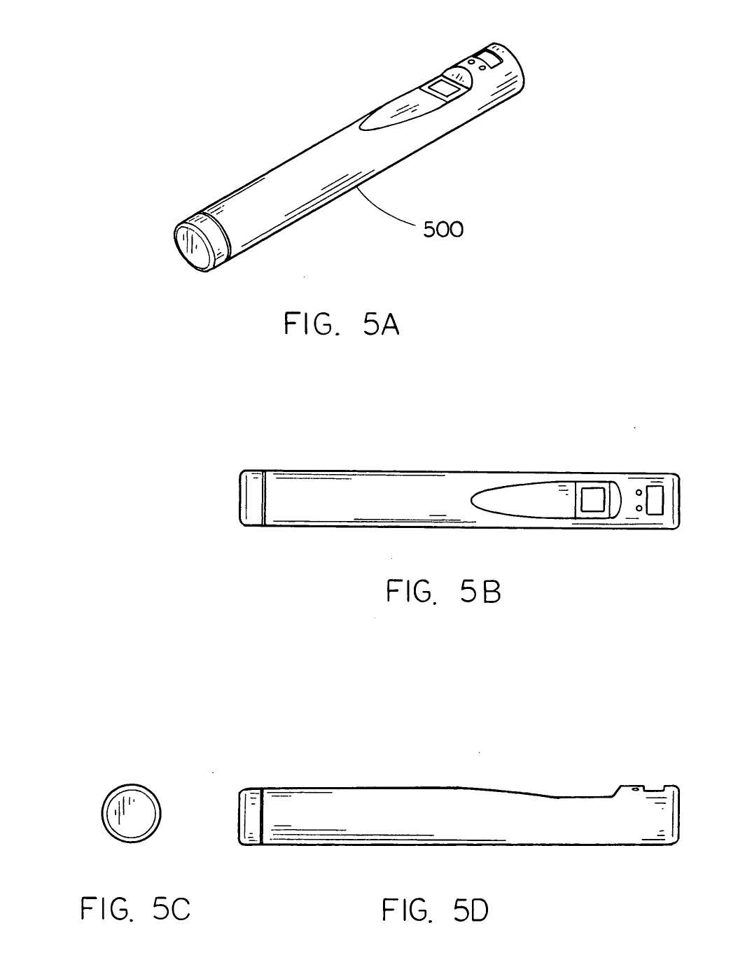

Referring to FIG. 4, multiple views of a release device 400 in accordance with an embodiment of the present invention is shown. Release device 400 may include a biometric sensor 410 for receiving a fingerprint of a user. Release device 400 may include a set of inputs 420 suitable for entering of a code. Entering of a proper code may also be required for release of a lock in accordance with an embodiment of the invention. Referring to FIG. 5, multiple views of an alternative embodiment of a release device 500 are shown. Release device 500 may also include a biometric sensor for sensing a biometric feature of a user; a memory; a processor for retrieving stored biometric data from the device memory, the processor being capable of comparing a received biometric feature with a stored biometric feature and a wireless transceiver for receiving and transmitting signals according to a wireless protocol. Release device 400, 500 may be self-contained and may allow enrollment of a biometric feature directly with the device 400, 500. While a release device is shown as a card and fob, release device may be implemented in any type of article without departing from the scope and intent of the present invention. Additionally, in one embodiment of the invention, release device may be in the form of a transaction authentication card as described in co-pending application Ser. No. 10/844,262.

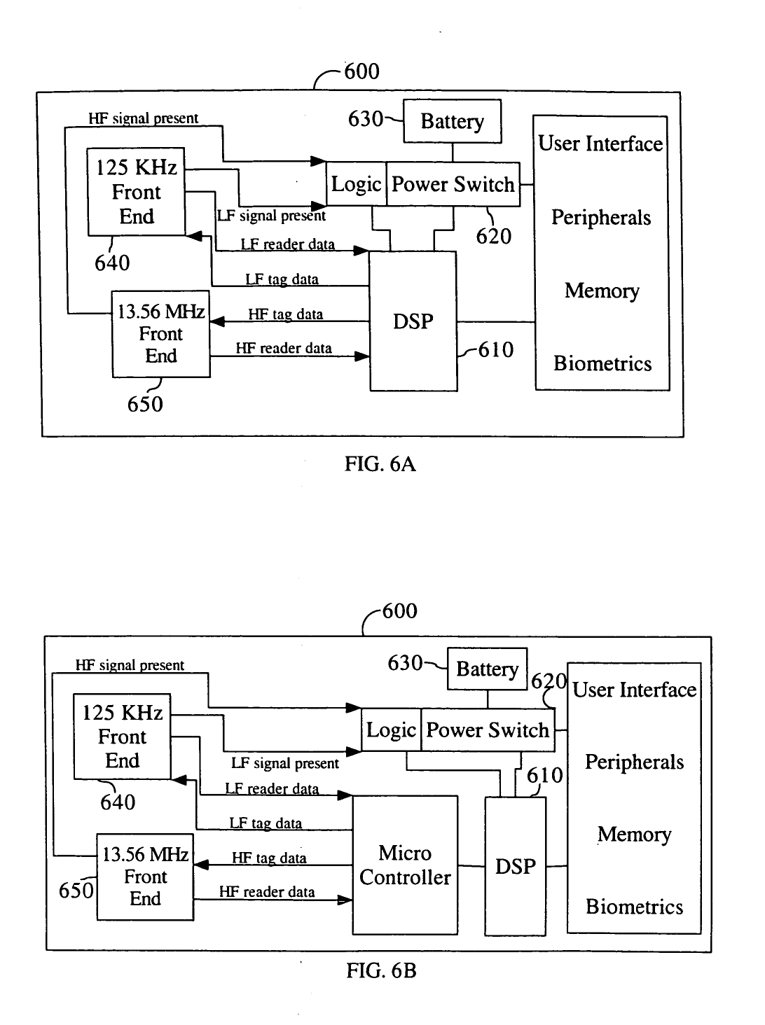

Referring generally to FIGS. 6A and 6B, exemplary block diagrams of release devices 600 are shown. Release device 600 may include a digital signal processor 610, power switch 620, battery 630, and multiple front ends 640, 650 whereby the sensor may be operable in a mixed environment, such as a 125 KHz and 13.56 MHz readers.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. An electromechanical lock system; comprising:
an electromechanical lock; and
a release device, said release device being suitable for releasing a lock of said electromechanical lock, wherein said electromechanical lock receives power from a power source external to said electromechanical lock and determines access for said release device according to a code received from said release device.

2. The electromechanical lock system as claimed in claim 1, wherein said power source external to said electromechanical lock is a battery.

3. The electromechanical lock system as claimed in claim 1, wherein said power source external to said electromechanical lock is an integrated power source of said release device.

4. The electromechanical lock system as claimed in claim 1, wherein power is received from said power source external to said electromechanical lock across a contact-less interface.

5. The electromechanical lock system as claimed in claim 1, wherein access is determined by comparing said code received from said release device against a stored code.

6. The electromechanical lock system as claimed in claim 1, wherein said release device includes a sensor for measuring a biometric feature.

7. The electromechanical lock system as claimed in claim 6, wherein said release device stores the biometric feature.

8. The electromechanical lock system as claimed in claim 7, wherein the code is not received from said release device when a measured biometric feature does not match a stored biometric feature.

9. A method for releasing an electromechanical lock, comprising:
receiving power from a power source external to an electromechanical lock;
receiving code from a release device;
determining if the code matches stored code;
releasing a lock when said code matches the stored code.

10. The method as claimed in claim 9, wherein said power source external to said electromechanical lock is a battery.

11. The method as claimed in claim 9, wherein said power source external to said electromechanical lock is an integrated power source of said release device.

12. The method as claimed in claim 9, wherein power is received from said power source external to said electromechanical lock across a contact-less interface.

13. A system for releasing an electromechanical lock, comprising:
means for receiving power from a power source external to an electromechanical lock;
means for receiving code from a release device;
means for determining if said code matches stored code; and
means for releasing a lock when said code matches the stored code.

14. The system as claimed in claim 13, wherein said power source external to said electromechanical lock is a battery.

15. The system as claimed in claim 13, wherein said power source external to said electromechanical lock is an integrated power source of said release device.

16. The system as claimed in claim 13, wherein power is received from said power source external to said electromechanical lock across a contact-less interface.

17. An electromechanical lock system; comprising:
an electromechanical lock; and
a release device, said release device being suitable for releasing a lock of said electromechanical lock, said release device being operatively coupled to said electromechanical lock via a contact-less interface, said release device including a sensor for measuring a biometric feature, a memory for storing the biometric feature and a power source, wherein said electromechanical lock receives power from said power source of said release device and determines access for said release device according to a code received from said release device.

18. The electromechanical lock system as claimed in claim 17, wherein said power source of said release device is a battery.

19. The electromechanical lock system as claimed in claim 17, wherein access is determined by comparing said code received from said release device against a stored code.

20. The electromechanical lock system as claimed in claim 17, wherein the code is not received from said release device when a measured biometric feature does not match a stored biometric feature.
